(19) United States
(12) Patent Application Publication
(10) Pub. No.: US 2023/0121148 A1
(43) Pub. Date: Apr. 20, 2023

(54) DIALOG SUPPORT APPARATUS, DIALOG SUPPORT METHOD AND PROGRAM

(71) Applicant: NIPPON TELEGRAPH AND TELEPHONE CORPORATION, Tokyo (JP)

(72) Inventors: Wataru AKAHORI, Tokyo (JP); Asuka MIYAKE, Tokyo (JP); Chihiro TAKAYAMA, Tokyo (JP)

(73) Assignee: NIPPON TELEGRAPH AND TELEPHONE CORPORATION, Tokyo (JP)

(21) Appl. No.: 17/910,802

(22) PCT Filed: Mar. 13, 2020
(86) PCT No.: PCT/JP2020/011193

§ 371 Date: Sep. 10, 2022

(51) Int. Cl. G10L 15/22; G10L 15/08

(52) U.S. Cl. CPC G10L 15/22; G10L 15/08; G10L 2015/088; G10L 2015/223; G10L 2015/225

(57) ABSTRACT

A dialog assistance apparatus facilitates a dialog by including a first estimation unit that estimates, with respect to a field related to speech content of a first speaker, a knowledge level of a second speaker having a dialog with the first speaker, an acquisition unit that acquires, from a storage unit that stores a question in association with a keyword and the knowledge level, a question corresponding to a keyword included in the speech content and corresponding to the knowledge level of the second speaker, and an output unit that outputs the acquired question to the first speaker.

### TECHNICAL FIELD

The present disclosure relates to a dialog assistance apparatus, a dialog assistance method, and a program.

### BACKGROUND ART

When two or more speakers are engaged in a dialog, it is difficult for them to speak according to the knowledge level of the opponent.

For example, when a dialog about Information and Communication Technology (ICT) is made between a speaker A who is highly literate in ICT (that is, who has a high level of understanding of ICT terms) and a speaker B who is less literate in ICT (that is, who has a low level of understanding of ICT terms), the speaker B may not understand what the speaker A says, and a breakdown of the dialog may occur.

Techniques have been devised heretofore to prevent the breakdown of the dialog between a user and a robot.

### CITATION LIST

### Patent Literature

PTL 1: WO 2017/200077

### SUMMARY OF THE INVENTION

### Technical Problem

The techniques in the prior art do not take into account the knowledge level of the speakers engaged in the dialog, and thus cannot help one speaker understand the content of the dialog of other speakers. As a result, it has been difficult to assist in facilitating the dialog.

The present disclosure has been made in view of the above, and it is an object of the present invention to assist in facilitating a dialog.

### Means for Solving the Problem

To achieve the object, a dialog assistance apparatus includes a first estimation unit that estimates, with respect to a field related to speech content of a first speaker, a knowledge level of a second speaker having a dialog with the first speaker, an acquisition unit that acquires, from a storage unit that stores a question in association with a keyword and a knowledge level, a question that corresponds to a keyword included in the speech content and that corresponds to the knowledge level of the second speaker, and an output unit that outputs the acquired question to the first speaker.

### Effects of the Invention

It is possible to assist in facilitating the dialog.

### BRIEF DESCRIPTION OF DRAWINGS

FIG. 1 illustrates an example of a hardware configuration of a dialog assistance apparatus 10 according to an embodiment of the present disclosure.

FIG. 2 illustrates an example of a functional configuration of the dialog assistance apparatus 10 according to the embodiment of the present disclosure.

FIG. 3 is a flowchart for explaining an example processing procedure of extracting a keyword from the speech content of a speaker A.

FIG. 4 is a flowchart for explaining an example procedure of dialog assistance processing.

FIG. 5 illustrates a configuration example of a knowledge level database (DB) 122.

FIG. 6 illustrates a configuration example of a question DB 123.

FIG. 7 illustrates contents of processing executed by the dialog assistance apparatus 10 in a specific example.

FIG. 8 illustrates a situation in which there is a plurality of persons who correspond to speaker B.

### DESCRIPTION OF EMBODIMENTS

Hereinafter, embodiments of the present disclosure will be described with reference to the drawings. The present embodiment assumes a situation in which a speaker A with high literacy (high knowledge level) and a speaker B with relatively low literacy (low knowledge level) in a certain field (for example, Information and Communication Technology (ICT)) have a dialog. For example, the speaker A may be a person who is in charge at the counter of a certain store, and the speaker B may be a person who consults the speaker A over the counter. This situation setting intends to facilitate understanding of the present embodiment and does not intend that the present embodiment is effective only in the above situation.

A dialog assistance apparatus 10 is placed where the speaker A and the speaker B have a dialog, to assist the dialog. The dialog assistance apparatus 10 may be shaped like a robot. Alternatively, a device such as a personal computer (PC), a smart phone, or the like may be utilized as the dialog assistance apparatus 10.

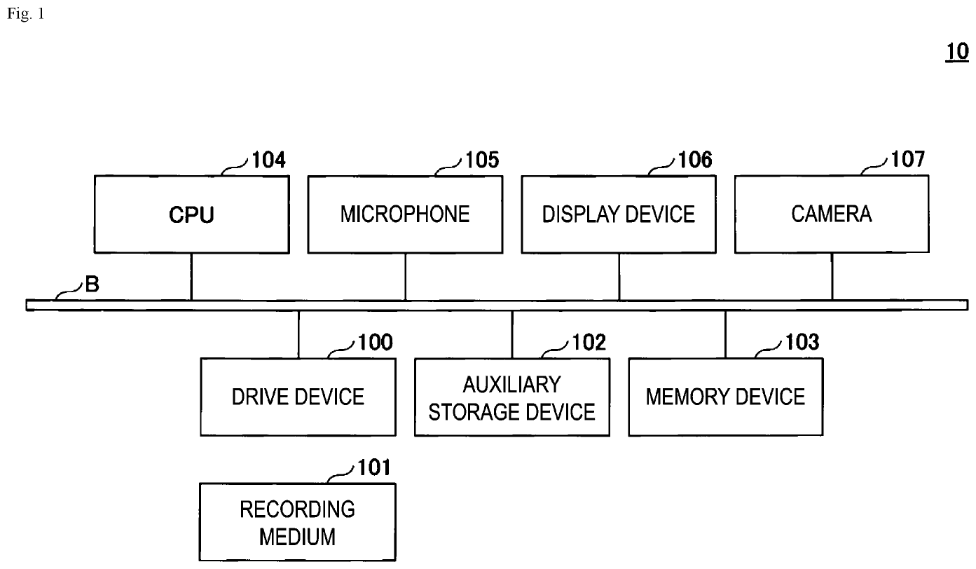

FIG. 1 illustrates am example of a hardware configuration of the dialog assistance apparatus 10 according to the embodiment of the present disclosure. The dialog assistance apparatus 10 illustrated in FIG. 1 includes a drive device 100, an auxiliary storage device 102, a memory device 103, a central processing unit (CPU) 104, a microphone 105, a display device 106, a camera 107, and the like, which are coupled to each other through a bus B.

A program for implementing processing performed by the dialog assistance apparatus 10 is provided as a recording medium 101 such as a compact disc read-only memory (CD-ROM). When the recording medium 101 storing the program is set in the drive device 100, the program is installed on the auxiliary storage device 102 from the recording medium 101 via the drive device 100. However, the program does not necessarily have to be installed from the recording medium 101 and may be downloaded from another computer via a network. The auxiliary storage device 102 stores the installed program and also stores necessary files, data, and the like.

The memory device 103 reads and stores the program from the auxiliary storage device 102 when the program is instructed to start. The CPU 104 implements functions relevant to the dialog assistance apparatus 10 in accordance with the program stored in the memory device 103. The microphone 105 is used to input voice of a dialog (in particular, speech content of the speaker A). The display device 106 is, for example, a liquid crystal display and is used to output (display) a question by voice to the speaker A when the speaker B is unable to understand the speech content of the speaker A, as will be described later. The display device 106 may be shaped like a window which is disposed, for example, between the speaker A and the speaker B. The camera 107 is, for example, a digital camera and used to input an image of the face (hereinafter referred to as a “face image”) of the speaker B. The microphone 105, the display device 106, the camera 107 may not be built in the dialog assistance apparatus 10, and may be connected to the dialog assistance apparatus 10, for example, wirelessly or by wire.

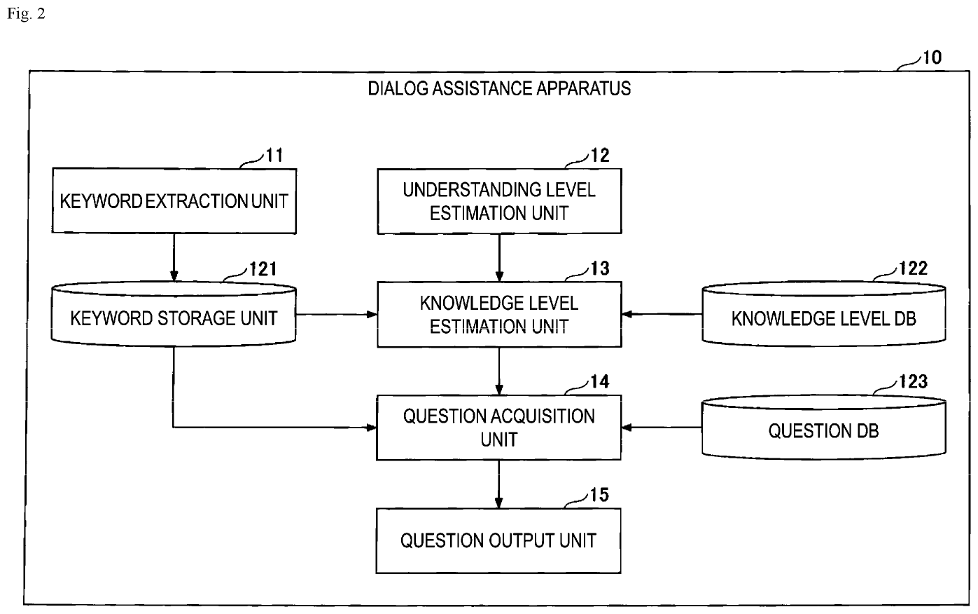

FIG. 2 illustrates an example of a functional configuration of the dialog assistance apparatus 10 according to the embodiment of the present disclosure. In FIG. 2, the dialog assistance apparatus 10 includes a keyword extraction unit 11, an understanding level estimation unit 12, a knowledge level estimation unit 13, a question acquisition unit 14, and a question output unit 15. These units are implemented by causing the CPU 104 to execute one or more programs installed in the dialog assistance apparatus 10. The dialog assistance apparatus 10 also utilizes a storage unit, such as a keyword storage unit 121, a knowledge level DB 122, and a question DB 123. These storage units can be implemented using, for example, the memory device 103, the auxiliary storage device 102, or a storage device connectable to the dialog assistance apparatus 10 via a network.

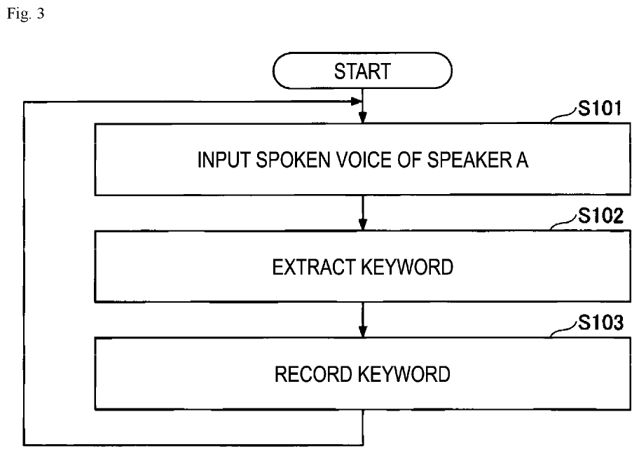

Hereinafter, processing executed by the dialog assistance apparatus 10 will be described. FIG. 3 is a flowchart for explaining an example processing procedure of extracting a keyword from the speech content of the speaker A. The processing procedure illustrated in FIG. 3 starts, for example, in response to the start of a dialog between the speaker A and the speaker B.

When the speaker A starts speaking, the keyword extraction unit 11 inputs the spoken voice of the speaker A via the microphone 105 (S101). For example, at the timing of the end of the speech, the keyword extraction unit 11 applies speech recognition to the spoken voice that has been input with respect to the speech, and extracts at least one keyword from text data acquired as a result of the speech recognition (S102). For example, “tethering” may be extracted as a keyword when the spoken voice is “do you use tethering?”.

Such keyword extraction can be performed using known techniques. For example, the keyword extraction may be performed using the method cited in “Keyword Recognition and Extraction for Speech-Driven Web Retrieval Task”, Masahiko Matsushita, Hiromitsu Nishizaki, Takehito Utsuro, and Seiichi Nakagawa, Information Processing Society of Japan, Research Report, Speech language information processing (SLP), 2003 (104 (2003-SLP-048)), 21-28. Alternatively, the keywords registered in the knowledge level DB 122, which will be described later, may be extracted.

Subsequently, the keyword extraction unit 11 records the extracted keyword in the keyword storage unit 121 (S103) and waits for the next speech of the speaker A (S101). In the keyword storage unit 121, the keywords are recorded in a manner that the order of extraction of the keywords (order of speeches) can be identified.

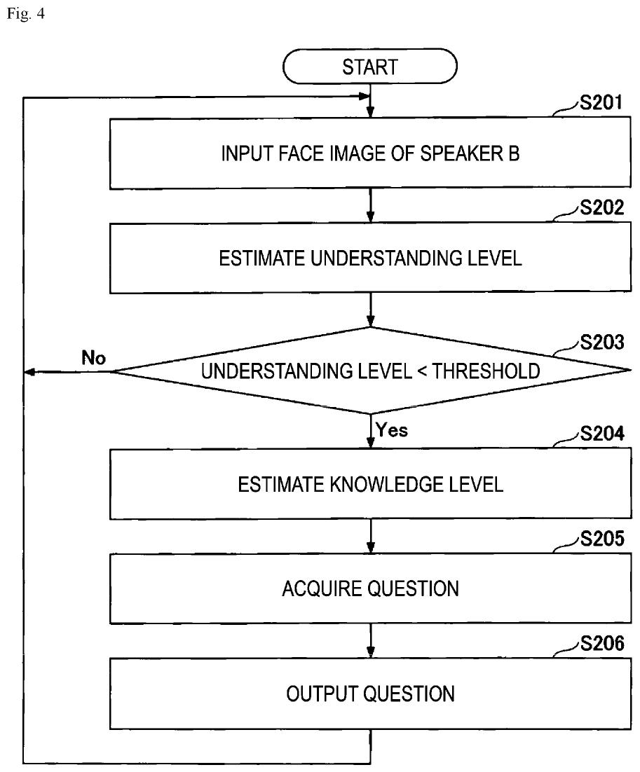

FIG. 4 is a flowchart for explaining an example procedure of dialog assistance processing. The processing procedure illustrated in FIG. 4 starts, for example, in response to the start of a dialog between the speaker A and the speaker B, and is executed concurrently (in parallel) with the processing procedure illustrated in FIG. 3.

The understanding level estimation unit 12 inputs the face image of the speaker B who is continuously captured by the camera 107 (S201), and estimates (calculates), based on the face image, the understanding level of the speaker B with respect to the speech content of the speaker A (S202). Specifically, the expression of the speaker B is likely to change when the speech content of the speaker A is difficult to understand. The understanding level estimation unit 12 thereby estimates the understanding level based on the expression of the speaker B. Such estimation of the understanding level may be performed using the technique described in, for example, “Understanding Presumption System from Facial Images”, Jun Mimura and Masafumi Hagiwara, IEEJ Journal of Industry Applications, C, 120 (2), 2000, 273-278. In that case, the understanding level is estimated in five levels (0 to 4) ranging from no understanding at all to a complete understanding. Although the understanding level is estimated using the input of the face image in the present embodiment, other understanding level estimation methods may be used. For example, the speech content of the speaker A or the speaker B may be input to estimate the understanding level using an existing speech recognition technique or text analysis technique.

Subsequently, the understanding level estimation unit 12 estimates whether the understanding level of the speaker B is smaller than a threshold (S203). Assume that, in the present embodiment, the lower the understanding value, the lower the level of understanding. In step S203, it is determined whether the speaker B has a low understanding level.

If the understanding level of the speaker B is equal to or greater than the threshold (No in S203), it is estimated that the speaker B is able to understand the speech content of the speaker A, and there is no need to assist the speaker B, so that the process returns to step S201. If the understanding level of the speaker B is smaller than the threshold (Yes in S203), the knowledge level estimation unit 13 estimates the knowledge level of the speaker B for the field (for example, ICT) related to the speech content of the speaker A in accordance with at least one keyword stored in the keyword storage unit 121 and the knowledge level DB 122 (S204). That is, how much knowledge the speaker B has for the field is estimated.

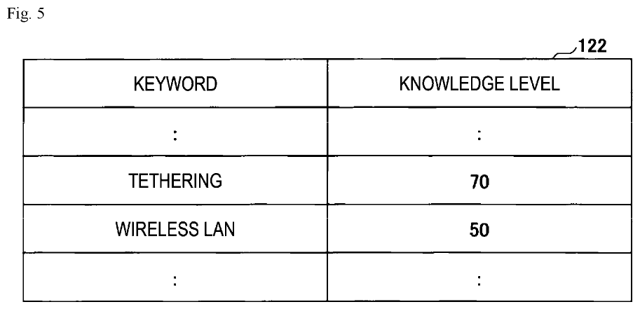

FIG. 5 illustrates a configuration example of the knowledge level DB 122. As illustrated in FIG. 5, the knowledge level DB 122 stores the knowledge levels in association with the keywords. Although FIG. 5 illustrates the example in which the knowledge levels are expressed by numerical values (scores), the knowledge levels may also be expressed by labels (for example, “high”, “medium”, “low”, and the like). The group of keywords used in step S104 (hereinafter referred to as a “target keyword group”) may only include a predetermined number of keywords or less, for example, the most recent N keywords. In the course of the dialog with the speaker A, it is likely that the topic changes over time. By limiting the target keyword group to include the most recent N keywords, the keywords that are less relevant to the current topic can be excluded from the target keyword group. Thus, an improved accuracy of estimation of the knowledge level can be expected with respect to the field related to the current topic. The keyword storage unit 121 may be a first-in, first-out (FIFO)) storage region in which only N keywords can be stored. The target keyword group may not be extracted from the speech content of the speaker A alone. For example, the target keyword group may also be extracted from the speech content of the speaker A and the speaker B in the most recent M dialogs. In this case, the spoken voice of the speaker B may be input in addition to the spoken voice of the speaker A in step S101 of FIG. 3.

When a plurality of keywords are included in the target keyword group, the understanding level estimation unit 12 may acquire, for example, the knowledge level from the knowledge level DB 122 for each target keyword, and estimate the lowest value of the acquired knowledge levels to be the knowledge level of the speaker B. Alternatively, the understanding level estimation unit 12 may estimate the highest value of the knowledge levels corresponding to any target keyword, which has been recorded in the keyword storage unit 121 before the understanding level is estimated to be smaller than the threshold, to be the knowledge level of the speaker B. This is because the speaker B is more likely to have understood the keywords that have been recorded before the understanding level is estimated to be smaller than the threshold.

In addition to the above, the technique disclosed in JP 2013-167765 A may also be used. In that case, the history of dialogs between the speaker A and the speaker B is recorded, and the knowledge level estimation unit 13 may estimate the knowledge level (knowledge amount) of the speaker B with reference to the history. Alternatively, the technique disclosed in JP 2019-28604 A may be used to estimate the knowledge level of the speaker B.

Subsequently, the question acquisition unit 14 acquires, from the question DB 123, the question to be output to the speaker A in accordance with the target keyword group and the knowledge level group estimated for the speaker B (S205).

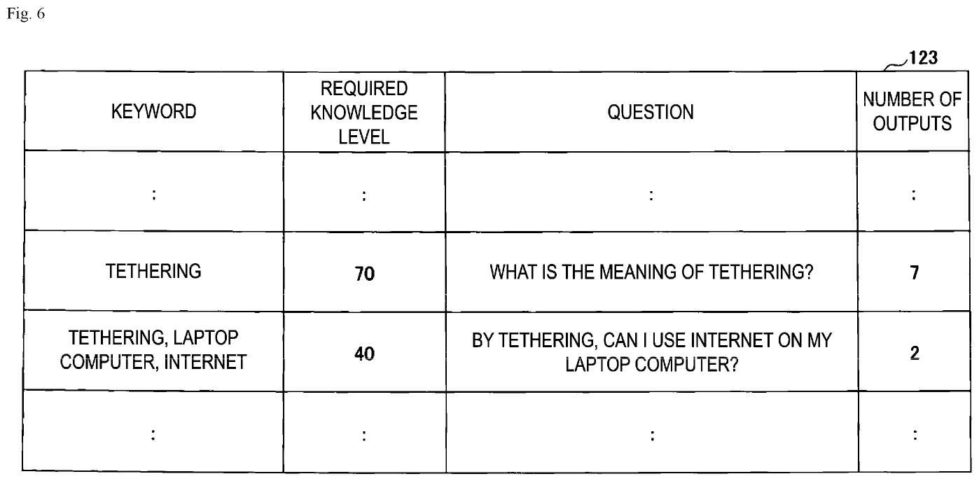

FIG. 6 illustrates a configuration example of the question DB 123. As illustrated in FIG. 6, each record of the question DB 123 stores “questions” and “number of outputs” in association with “keywords” and “required knowledge levels”. The “question” of each record indicates the question that should be output when a person who does not understand the “keyword” of that record has a knowledge level equal to or greater than the “required knowledge level” of that record. In addition, the “number of outputs” for each record indicates the number of times the “question” of the record has been output in the past.

Accordingly, in step S205, the question acquisition unit 14 acquires the “question” from the record that includes any keyword included in the target keyword group in the “keyword” and that indicates the “required knowledge level” to be equal to or smaller than the knowledge level of the speaker B. When there are a plurality of “questions”, the questions may be sorted, for example, in descending order of the “number of outputs”.

Subsequently, the question output unit 15 outputs (displays) the question acquired by the question acquisition unit 14 to the display device 106 (S206). The display device 106 is disposed to be visibly recognizable by the speaker A and the speaker B.

Then, the speaker A speaks the answer to the question. In accordance with the question and the answer, it can be expected that the speaker B is able to understand the speech content of the speaker A, which the speaker B could not understand before.

The following is a specific example of the dialog between the speaker A and the speaker B and the questions output by the dialog assistance apparatus 10.

A(1): “Do you use wireless LAN at home?”

### B(1): “Yes.”

A(2): “Do you use tethering when you are out?”

### B(2): “Well . . . .”

Dialog assistance apparatus 10: “By tethering, can I use the Internet on my laptop computer?”

### A(3): “Yes.”

B(3): “I do not use my laptop computer outside, so I do not think I use tethering.”
In the above, A(m) (m=1 to 3) represents the speech uttered by the speaker A. B(m) (m=1 to 3) represents the speech uttered by the speaker B. In this dialog, step S202 and subsequent steps are performed according to the facial expression of the speaker B when he/she has spoken “Well . . . ”. In step S206 performed as a result, the dialog assistance apparatus 10 outputs the question “By tethering, can I use the Internet on my laptop computer?” to the speaker A on behalf of the speaker B. In response, the speaker A answers (“Yes.”). This answer allows the speaker B to respond to the speech A(2) (speech B(3)) even if the speaker B does not fully understand the meaning of “tethering”, thus facilitating the dialog between the two. In other words, the dialog between the two has become engaged and the breakdown of the dialog is avoided.

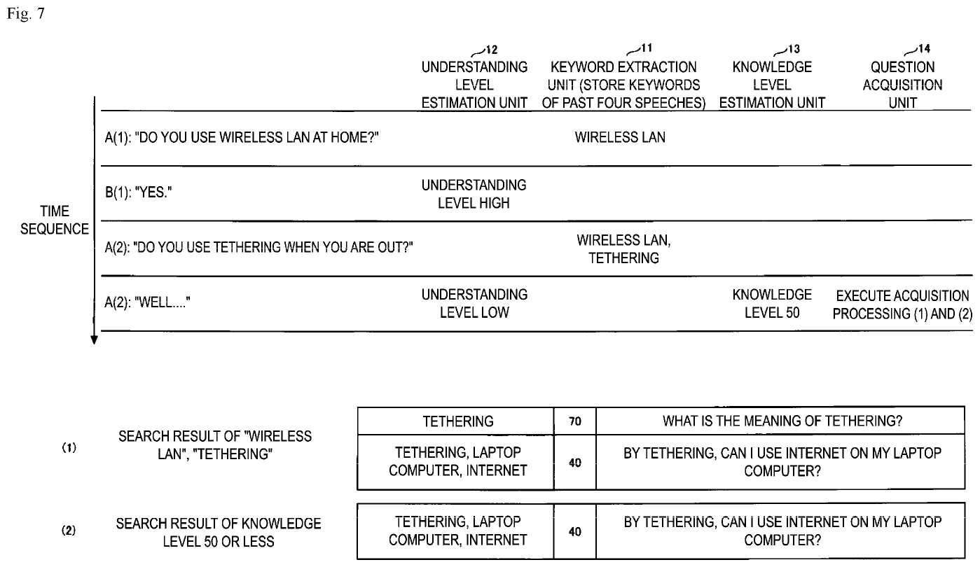

FIG. 7 illustrates processing contents performed by the dialog assistance apparatus 10 in the specific example. In FIG. 7, in the speech A(1), the keyword extraction unit 11 extracts “wireless LAN” as a keyword. At the timing of the subsequent speech B(1), the understanding level estimation unit 12 estimates the understanding level of the speaker B to be “high”. Accordingly, the knowledge level estimation unit 13 and the question acquisition unit 14 do not execute processing. In the subsequent speech A(2), the keyword extraction unit 11 extracts “tethering” as a keyword. In the illustrated example, up to four keywords are stored in the keyword storage unit 121. At this point, the keyword storage unit 121 stores two keywords: “wireless LAN” and “tethering”. At the timing of the subsequent speech B(2), the understanding level estimation unit 12 estimates the understanding level of the speaker B to be “low”. In response, the knowledge level estimation unit 13 estimates the knowledge level of the speaker B to be “50”, and the question acquisition unit 14 acquires, from the question DB, the record shown in (2) in FIG. 7 from among the record group shown in (1) in FIG. 7. (1) shows the group of records including any keyword of the target keyword group (“wireless LAN” and “tethering”) as the “keyword”. (2) shows the record having the “required knowledge level” equal to or smaller than 50 among the group of records shown in (1).

In this case, like the specific example described above, the question output unit 15 outputs the question “By tethering, can I use the Internet on my laptop computer?” on behalf of the speaker B. Although the present embodiment has described the example in which the output form of the question is display, the question output unit 15 may also output the question by voice. In that case, the dialog assistance apparatus 10 needs to include a speaker.

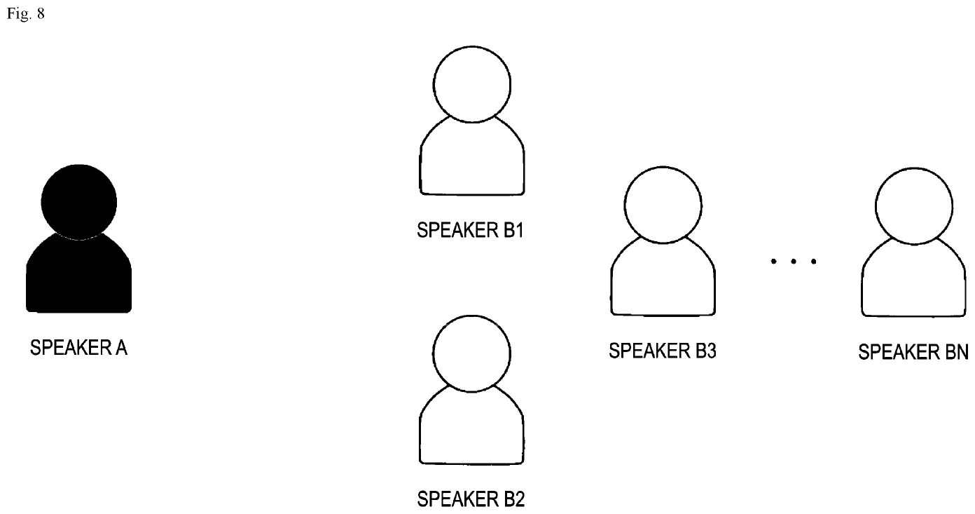

Another case is assumable, as illustrated in FIG. 8, in which a person corresponding to the speaker B (for example, a person who consults with the speaker A) is a group of a plurality of persons (speaker B1 to speaker BN in FIG. 8). Assuming such a case, a threshold for the number of speakers corresponding to the speaker B may be set in the dialog assistance apparatus 10 such that the question output unit 15 does not output a question if the number of persons exceeds the threshold. In this manner, for example, each speaker B can avoid being inferred by other speakers B that his/her knowledge level is low by outputting the question from the dialog assistance apparatus 10.

Even when a plurality of speakers B are present, there may be no need to limit the output of the question based on the threshold. In this case, the understanding level estimation unit 12 may estimate the understanding level of each speaker B (in parallel), and the knowledge level estimation unit 13 may estimate the knowledge level of each speaker B (in parallel). The question acquisition unit 14 may acquire, from the question DB 123, the question to be output to the speaker A based on the lowest knowledge level among a plurality of the estimated knowledge levels (in parallel). In this manner, the question may be output according to the speaker B having the lowest knowledge level.

In accordance with the present embodiment, as described above, when the speaker B cannot understand the speech content of the speaker A (the content of the dialog with the speaker A), the dialog assistance apparatus 10 outputs (gives notice of) the question to the speaker A according to the knowledge level of the speaker B on behalf of the speaker B. As the speaker A answers the question, the speaker B can respond to the speech content based on the answer without fully understanding the speech content. This makes it possible to assist in facilitating the dialog.

In the present embodiment, the knowledge level estimation unit 13 is an example of a first estimation unit. The question acquisition unit 14 is an example of an acquisition unit. The question output unit 15 is an example of an output unit. The understanding level estimation unit 12 is an example of a second estimation unit. The speaker A is an example of a first speaker. The speaker B is an example of a second speaker.

Although the embodiments of the present disclosure have been described in detail above, the present disclosure is not limited to such specific embodiments, and various modifications and change can be made within the scope of the gist of the present disclosure described in the aspects.

### REFERENCE SIGNS LIST

10 Dialog assistance apparatus
11 Keyword extraction unit
12 Understanding level estimation unit
13 Knowledge level estimation unit
14 Question acquisition unit
15 Question output unit
100 Drive device
101 Recording medium
102 Auxiliary storage device
103 Memory device
104 CPU
105 Microphone
106 Display device
107 And Camera
121 Keyword storage unit
122 Knowledge level DB
123 Question DB
B Bus

1. A dialog assistance apparatus comprising a processor configured to execute a method comprising:
estimating, with respect to a field related to speech content of a first speaker, a knowledge level of a second speaker having a dialog with the first speaker;
acquiring, a question corresponding to a keyword included in the speech content and corresponding to the knowledge level of the second speaker; and
outputting the acquired question to the first speaker.

2. The dialog assistance apparatus according to claim 1, further comprising:
estimating an understanding level of the second speaker with respect to the speech content of the first speaker, wherein
the outputting further comprises outputting the question to the first speaker according to the understanding level.

3. A computer implemented method for dialog assistance, the method comprising:
estimating, with respect to a field related to speech content of a first speaker, a knowledge level of a second speaker having a dialog with the first speaker;
acquiring a question corresponding to a keyword included in the speech content and corresponding to the knowledge level of the second speaker; and
outputting the acquired question to the first speaker.

4. A computer-readable non-transitory recording medium storing computer-executable program instructions that when executed by a processor cause a computer to execute a method comprising:
estimating, with respect to a field related to speech content of a first speaker, a knowledge level of a second speaker having a dialog with the first speaker;
acquiring a question corresponding to a keyword included in the speech content and corresponding to the knowledge level of the second speaker; and
outputting the acquired question to the first speaker.

5. The dialog assistance apparatus according to claim 1, wherein the knowledge level is associated with a label, and the label includes one of: high, medium, or low.

6. The dialogue assistance apparatus according to claim 1, wherein the knowledge level is based on a history of dialogs between the first speaker and the second speaker.

7. The dialogue assistance apparatus according to claim 1, wherein the knowledge level of the second speaker is associated with an expression of the second speaker determined in captured image data.

8. The dialogue assistance apparatus according to claim 1, the processor further configured to execute a method comprising:
outputting, based on a threshold associated with a number of speakers in dialog with the second speaker, the acquired question to the first speaker.

9. The computer implemented method according to claim 3, further comprising:
estimating an understanding level of the second speaker with respect to the speech content of the first speaker, wherein
the outputting further comprises outputting the question to the first speaker according to the understanding level.

10. The computer implemented method according to claim 3, wherein the knowledge level is associated with a label, and the label includes one of: high, medium, or low.

11. The computer implemented method according to claim 3, wherein the knowledge level is based on a history of dialogs between the first speaker and the second speaker.

12. The computer implemented method according to claim 3, wherein the knowledge level of the second speaker is associated with an expression of the second speaker determined in captured image data.

13. The computer implemented method according to claim 3, further comprising:
outputting, based on a threshold associated with a number of speakers in dialog with the second speaker, the acquired question to the first speaker.

14. The computer-readable non-transitory recording medium according to claim 4, the computer-executable program instructions when executed further causing the computer to execute a method comprising:
estimating an understanding level of the second speaker with respect to the speech content of the first speaker, wherein
the outputting further comprises outputting the question to the first speaker according to the understanding level.

15. The computer-readable non-transitory recording medium according to claim 4, wherein the knowledge level is associated with a label, and the label includes one of: high, medium, or low.

16. The computer-readable non-transitory recording medium according to claim 4, wherein the knowledge level is based on a history of dialogs between the first speaker and the second speaker.

17. The computer-readable non-transitory recording medium according to claim 4, wherein the knowledge level of the second speaker is associated with an expression of the second speaker determined in captured image data.

18. The computer-readable non-transitory recording medium according to claim 4, the computer-executable program instructions when executed further causing the computer to execute a method comprising:
outputting, based on a threshold associated with a number of speakers in dialog with the second speaker, the acquired question to the first speaker.
